(19) United States
(12) Patent Application Publication
(10) Pub. No.: US 2015/0088937 A1
(43) Pub. Date: Mar. 26, 2015

(54) Systems and Methods of Mapping Locales

(71) Applicants: Darrin K. Lons, Reidsville, NC (US); R Brett Lons, Pilot Mountain, NC (US); Ryan Lons, Pilot Mountain, NC (US)

(72) Inventors: Darrin K. Lons, Reidsville, NC (US); R Brett Lons, Pilot Mountain, NC (US); Ryan Lons, Pilot Mountain, NC (US)

(21) Appl. No.: 14/484,412

(22) Filed: Sep. 12, 2014

Related U.S. Application Data
(60) Provisional application No. 61/880,749, filed on Sep. 20, 2013.

(51) Int. Cl. G06F 17/30

(52) U.S. Cl. CPC G06F 17/30312
USPC 707/803

(57) ABSTRACT

The present invention relates to one or more applications and/or programs that may be used on a smart phone, on a computer, or on a computer like device. The one or more applications and/or programs are able to receive input from one or more users or may automatically receive information from web sites that allows the mapping of establishments and may also create a database that contains relevant information that can be used by consumers and various establishments. When a user accesses the one or more applications and/or programs, the one or more applications and/or programs can provide the user with information such as the best route to take so that the user will arrive at a given product. The present invention may also be able to map other locales. Other advantages that may be provided by the one or more applications and/or programs include raising revenue, offering better service to the public, auditing emergency procedures and other procedures, inventorying goods and/or products, studying the effects of marketing, testing the effectiveness of staging, reducing costs, and/or evaluating vender and/or service providers.

This application claims priority under 35 USC 119(e) to U.S. Provisional Application No. 61/880,749 filed Sep. 20,2013, the entire contents of which are herein incorporated by reference in its entirety.

### FIELD OF THE INVENTION

The present invention relates to systems and methods for mapping retail, wholesale, factory or other locations. In an embodiment, the systems and methods of the present invention can be used for/by a consumer to easily locate products. map venues, can be used to assign seating, can be used to assign rooms or areas, or can be used at attractions, and/or for services at a retail, wholesale, medical facility, sporting venue, entertainment venue, collegiate, or other facilities and/or locations. In an embodiment, the systems and the methods may be an application that is accessible on a computer and/or on a computer-like device such as a mobile device such as an IPad, an IPod, tablets, Google glasses, and/or on a smart phone.

### BACKGROUND OF THE INVENTION

With the advent of the internet and personal computers, users have more accessible information at their fingertips. Users have been able to access mapping programs such as Google maps, Mapquest or other mapping programs. However, there has been a scarcity of usable maps that provide the user with mapping information related to retail establishments or other individual venues.

### BRIEF SUMMARY OF THE INVENTION

In an embodiment, the present invention relates to systems and methods for collecting data, and metrics gathered from the public users taking advantage of the convenience, and savings potential of the public user embodiment of the invention.

In an embodiment, the present invention relates to mapping or presenting diagrams of organizations' sites and facilities including relative locations of products located therein. Thus, in an embodiment, the users may be guided to products, services, and attractions. In an embodiment, the present invention is designed to encourage the public to participate in the organizations efforts to learn more about the public. The organizations' interests in reactions to various stimuli in the retail, social, entertainment, sporting arenas, as well as other settings must be tightly linked to public user activity in those venues. To further encourage public participation in these efforts, in one embodiment the invention may offer savings potential suggestions to alternative products, services and attractions, as well as other conveniences as outlined and described further in the rest of this document.

### BRIEF DESCRIPTION OF THE SEVERAL VIEWS OF THE DRAWING

FIG. 1 shows the Organization Process and/or Procedure.

FIG. 2 shows the public user Search and/or List Functionality.

FIG. 3 shows public user's Location Acquisition.

FIG. 4 shows Data Collection and/or Feedback Process.

FIG. 5 shows Data Collection, Analysis, and/or Reporting Process.

### DETAILED DESCRIPTION OF THE INVENTION

In an embodiment, the present invention relates to systems and/or methods for collecting data from retailers, wholesalers or others, and metrics gathered from the public users taking advantage of these systems and/or methods. The systems and/or methods provide a convenience to the user in that it allows the user to rapidly locate goods and/or products from this collection of data. Moreover, in an embodiment, the systems and/or methods of the present invention lead to savings for the public or any potential user.

In one embodiment, the invention functions to map and/or present diagrams or other displays of organizations' sites and facilities. In an embodiment, the systems and/or methods allow a user to locate goods and/or products, and it guides users to products, services, and attractions. In an embodiment, the systems and/or products are designed to encourage the public to participate in the organizations efforts to learn more about the public. In one embodiment, the organization's interests in reactions to various stimuli in the retail, social, entertainment, sporting arenas, as well as in other settings may be lightly linked to public user activity in those venues. Accordingly, by being able to ascertain the public user activity, information can be gleaned about those various stimuli. In one embodiment, the present invention is able to encourage public participation in these efforts, which may offer savings potential. Moreover, in a variation, the application may provide suggestions to alternative products, services and attractions, as well as other conveniences as will be outlined and described further in the rest of this document.

In an embodiment, all of these offerings to the public are designed as a means for participating organizations, their vendors and service providers, to gain access to and provide analysis of this data in an effort to provide a plurality of outcomes including but not limited to raising revenue, offering better service to the public, auditing emergency procedures and other procedures, inventorying goods and/or products, studying the effects of marketing, testing the effectiveness of staging, reducing costs, ascertaining traffic flow patterns and/or evaluating vender and/or service providers, and providing services. Accordingly, in an embodiment, the system may be used to provide services such as seating (including directing a user to seat locations) at events such as sporting events. The system may also be used to assign one or more rooms (such as at a hotel of a convention center or other facility wherein space is often allocated).

In an embodiment, the present invention is able to raise revenues by providing the user with information as to where goods and/or products and/or services can be located allowing the user to purchase goods more rapidly. In an embodiment, the present invention is able to offer better service to the public by displaying and/or mapping goods, products and/or services allowing the user to more rapidly (e.g., more efficiently) to locate and/or purchase goods or to make comparison shopping more readily available. In an embodiment, the present invention is able to audit such things as planograms, emergency procedures, crowd control efforts, and security issues, which increases the safety of retail, wholesale or other establishments. In an embodiment, the present invention is able to study the effects, and results of various promotional or marketing campaigns. The present invention may have sales data available to it that can be manipulated to ascertain if a marketing campaign was effective (e.g., if sales increased at a time when the marketing took place). In an embodiment, the present invention allows one to test the effectiveness of various staging or display methods, and models. In a variation, the present invention allows one to evaluate vendor and service providers' effectiveness and contribution to bottom line profits. In an embodiment, the present invention allows one to reduce costs; to reduce losses both in revenue and manpower costs and to recover the lost revenue from abandoned or incomplete public purchases.

In one embodiment, the present invention gathers data for various clients, hereafter known as “organizations”. The gathered data may lead to one of the outcomes described above and will provide the organizations with data that provides the organizations with a competitive advantage over their competitors. In an embodiment organization participation fees may be the primary source of revenue for the invention. Other fees may be paid to the application/program provider from the sales of the application and/or user fees. In an embodiment, the present invention allows participating retailers, participating organizations, vendors and service providers to have their inventories mapped as described below in the discussion that follows.

The data collected will depend not only on the inventories of the participating organizations, but also on the nature of the organization, the customers or clientele about whom they are interested in collecting metrics/data, and various other factors. These factors comprise, but are not limited to, such things as the weather, the region or country where they are located, demographic data, political areas of influence, the time of day, the time at the organization's location, their age(s), income level, ethnicity, religious affiliation, civic clubs memberships, leisure activities, number of people in the household, vendor requirements, service provider issues, quality control concerns (e.g., plan-o-gram auditing), promotions or “deals”, results from competitive comparisons, public users' (e.g., retail shoppers) histories, and favorites, and results from organization provided suggestions/alternatives to the public user.

As technology and tools advance, and social trends come and go, other incentives and points of influence for participating organizations will be implemented, improved, reconfigured, or phased in/out of the invention. That is, the invention will adapt to social and technological changes.

Public participation and therefore access to the public's patterns, spending habits and other data and/or metrics is accomplished by offering convenience and money saving opportunities to public users. One embodiment of the invention is geared toward providing various tools and means for the public to interact with the invention via web sites, mobile devices (i.e. mobile phones, tablets, and computers) and other future technologies.

Cost savings, search and list functions, location maps, information sharing, feedback to organizations and competitive shopping results are but a few of the features of the invention that will attract, and retain public users to this process. See the figures for exemplary features of the present invention and for specific embodiments.

In one embodiment, the invention comprises two sets of tools to attract public users, and to implement data collection for the participating organizations. The following sections of this description are intended to present the methods and processes involved tor the organization, as well as the public user.

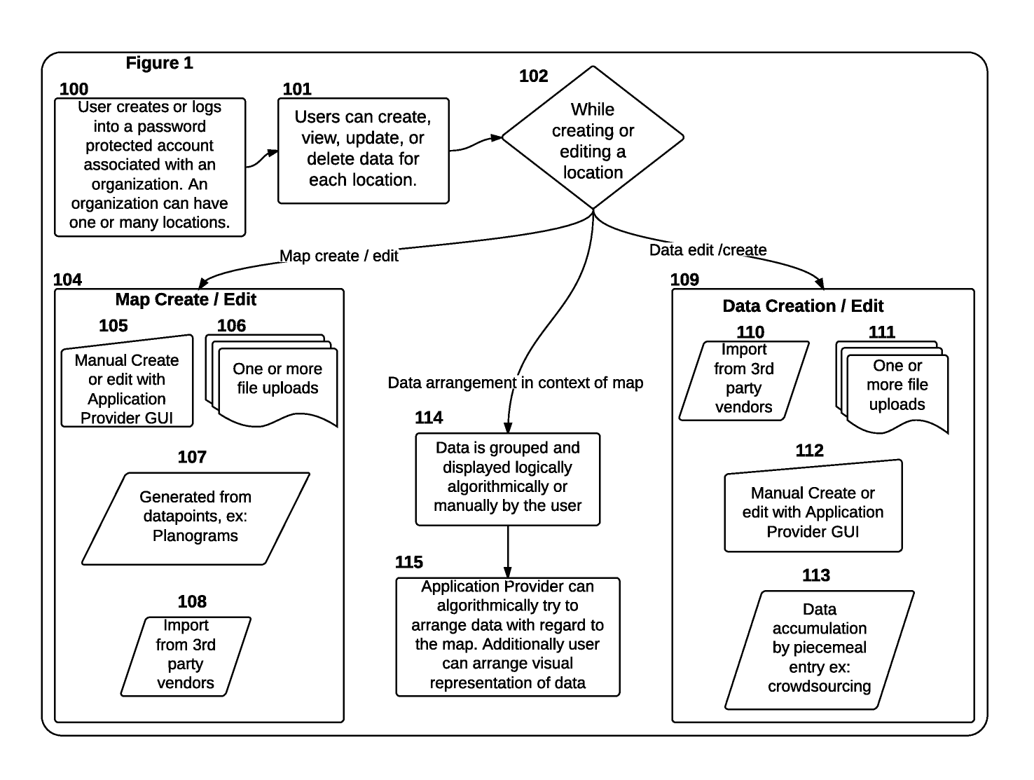

In one embodiment, the present invention is able to set up displays of an organization's inventory as shown in FIG. 1. As shown in FIG. 1, a user creates and/or logs into a password protected account associated with an organization (100). In one embodiment, the user who has accessed, the account can edit data for a particular location (101). Alternatively and/or additionally, the user can create or edit a location (102). In an embodiment the user can edit or create features related to the mapping (104) or edit and create features related to data (109). As exemplary embodiments, the editing or creating features associated with mapping (104) include but are not limited to creating or editing features associated with the application provider's graphical user interface (GUI) (105), file uploads (106), imports from 3^{rd} party vendors (108), or maps generated/edited from data points (107). As exemplary embodiments, the editing or creating features associated with data include but are not limited to data imported by a third party (110), files uploaded by the user or another party (111), manually created or edited data that is created or edited with the application provider GUI (112) and/or piecemeal entry of data that generates accumulated data such as that done by crowdsourcing (113). Once the mapping and/or data has been created or edited, the data may be grouped and displayed logically or algorithmically by the user (114) and/or the data and/or map can be arranged algorithmically by the application provider (115).

In one embodiment, the participating organization may be asked to complete a non-disclosure, or do not compete agreements with the application provider. In one variation, the application provider will provide an email or text message invitation to the organization's authorized project leader or IT staff to set up a corporate application provider account. In one embodiment, using the application provider secure participating organization website section, said staff will create and manage location accounts, and implement basic authorized user accounts for each location. Upon completing the location account forms, the participating organization may send invitation emails to each of the people responsible for implementing and maintaining the application provider location account. Upon receipt of the invitation, these authorized users will log on and may complete a detailed user account form, including private password, contact information, affiliation to store number, or numbers, and their job title and responsibilities. The application provider may confirm the accuracy of this data with the organization's corporate management and release the account for use by associates, affiliates or others associated with the organization. Once the accounts are active, the location staff may begin the setup of their particular location as outlined and described below.

### Step #1

In one variation, step one may comprise creating a map, diagram or floor plan. In one embodiment, the organization, with optionally the assistance of the application provider's tools will import, upload or create a map, diagram or floor plan, and description of a given location. In several embodiments, the mapping and data entry may be created manually or by using tools and templates on a web site (such as on the application provider's web site). The templates may comprise an uploaded file from the organization's server as an image or could be uploaded and interpreted from some sort of CAD file. Other means of importing data and/or maps are contemplated such as 3rd party data sources such as a planogram vendor, generating maps from raw data points provided by data files, or a 3rd party vendor, as in, given very precise planograms that can be reverse engineered to create a store, factory, retail establishment or other location layout. Maps can be generated in a number of ways; first, maps may be generated manually or the retailer can export data from its storage system as CSV (cluster shared volumes) or similar type files. In an embodiment, maps may be generated by RESTful web services using JSON, but may include SOAP and XML endpoints or something like TCP Sockets. Further, maps and diagrams could be generated from data provided by scanning devices and software, e.g., advanced AR (augmented reality), LIDAR (light detection and ranging), robot mapping, and/or RF (radio frequency) technologies. Still other sources of maps and diagrams may include but are not limited to downloads from organization and/or vendor web sites, access to digitally stored “public information” like city, county, state zoning and planning databases, digital scans of construction, and architectural drawings, construction bid specifications, and/or data from military specifications regarding requirements for bidding/construction practices and materials.

### Step #2

In a second step, the data may be organized for example by spatial organization of data with regard to the floor plan site map, or diagram obtained via step 1. In one variation, this can be accomplished by manual arrangement of data points or groups of data points with our Application Provider's user interlace (UI) tools. Additionally and/or alternatively, one option of organization can be achieved by dragging shelving symbols around the map from planogram data.

In an embodiment automatic arrangement can be accomplished using the content of the data file itself and technological means of identification and location of shelving or display cases e.g., if a shelf has X,Y coordinates, and/or optionally a Z coordinate or GPS coordinates for its location, then overlay planogram or product placement data can be displayed from a file onto the map and/or diagram.

In one embodiment, mixed solutions can be offered. For example, aisles may be auto-generated, but the endpoint may be manually specified. Alternatively and/or additionally, product placement files may sequence through an aisle of shelving, but may need to have a start and end point entered manually. Shelving/display case identifiers, attractions identifiers, and the like may be entered into the product or points of interest locator files as additional data fields and may be then automatically assigned to that particular group of products or points of interest.

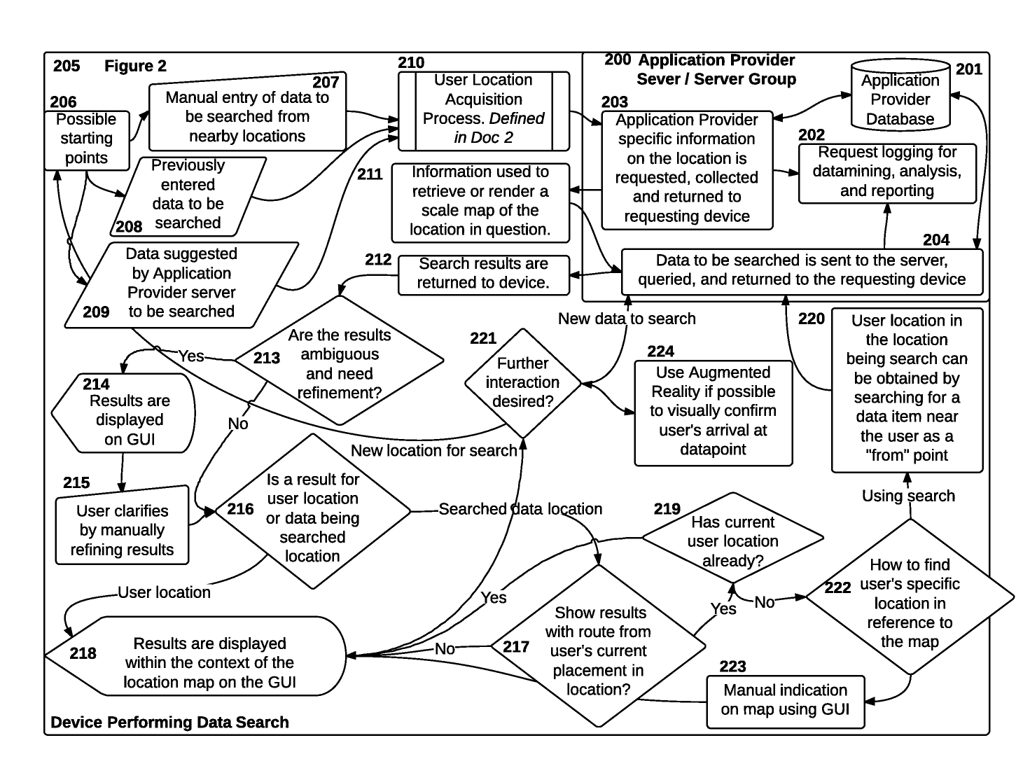

Public user Search and List Functionality—FIG. 2.

For the purpose of this document, a “device” is defined as any hardware/software system capable of utilizing the systems, methods and/or processes of the present invention in various locations or venues. These include but are not limited to, cellular telephones, tablets, computers, mobile computers, Google glasses or any other means of utilizing the invention, including web page readers, braille processors, audible devices or any pertinent future technology, hardware or software capable of using the invention in present or subsequent future embodiments.

FIG. 2 shows one embodiment of a search process of the present invention. In one embodiment, the system allows a public user to perform a search about a certain data item at a location and have the results displayed either graphically or by some other means by marking the location(s) of that data item on the map. For example, one example might show the public user where peanut butter is in a grocery store, or alternatively, show all rest rooms at a large music venue, show stores at a mall, show enclosures at a zoo, show gates/flights/eta or other information at airports, or display items from a shopping list in an optimized route through a retail store. To begin the search, the application provider may implement a search string(s) and the location for the context of the search (206)-(210). In one embodiment, the process by which the application provider determines which location to search is diagramed in FIG. 2 (210).

The device performing the search makes a request to the application provider (203) which is in turn logged (202). In one embedment, the application provider queries its database (201) and returns only the information about the location that is necessary for displaying search results. This may include a URL to a file on the internet for the image file of the map or the actual binary data for the image. In one embodiment, if the image of the map is quite large, it may be broken into tiles for piecemeal downloading to the searching device(s). This is a performance and ease of use solution for large files. The effect being the public user is not forced to wait for a potentially very large file to load before they can begin taking advantage of the mapping feature (211). It is contemplated that as the bandwidth of devices increase, files may not need to be broken into tiles for piecemeal downloading. Accordingly, the present invention contemplates entire files or even a plurality of different files being instantaneously and/or simultaneously downloaded.

In one embodiment, the next step may be for the device performing the search to send a request to the application provider server(s) with the string to be searched (204), the server may log the request (202), and the application provider queries its database for matches to the query string for the data items(s) at that specific location. Upon search completion, in one embodiment, the application provider responds to the device requesting the results (212). The results returned may have many matches and manual clarification may be required from the public user (213). If clarification is needed, a list of the search results can be displayed to the public user for manual clarification.

Further, with a specific result to display, that data item may be marked on the map and displayed to the public user. The display on the map may include instructions as to how to proceed, barriers, or temporary conditions like closures, or remodeling efforts that will affect the public user's ability to get to the marked position on the map. Such conditions might be provided by the local site personnel responsible for implementing and maintaining the application provider functionality at their site. This mark may just be a single marker or may be an optimized path from the public user's current location to the target data item(s). If a path from the public user's location to the searched data is requested, the application provider knows relatively where the public user is located at the location being searched (217), (219). The location of the public user can either be input manually or alternatively, the location may be ascertained by GPS technology associated with the public user's device. Alternatively and/or additionally, location in some embodiments can be determined by WiFi signals near a device and databases that determine locations based upon those WiFi signals. In one embodiment, the system of the present invention does not store GPS coordinates but rather may look up longitude and latitude from third party services. One advantage of this is that space and memory is not occupied by the storage of coordinates allowing the application software to be processed more rapidly. Examples of other services that can be used to generate location data include Facebook Places API, Google Places API, and Foursquare API. In one embodiment, the application uses globally unique ID for nearby locations to do a lookup in the system to see if the application has data for any of those locations' IDs.

In an embodiment, if the application provider does not have the public user's location at the location, it can be ascertained by the public user telling the application provider what data items are near to him or her. An example of this would be for the public user to tell the application provider that they are near the bananas and are Looking for peanut butter. With this data, the application provider cm find both data items' locations and draw a path between them on the map. Alternatively and/or additionally, for a list of items, a path connecting all items in a route optimized for distance can be calculated and drawn on the map with graphic marks denoting each stop in the route for each item on the list. All of these solutions require no additional hardware or new systems or wiring (including associated installation and maintenance costs) to the organization. Using modern mobile devices, the application provider provides cost savings in this area for the organization.

Alternatively and/or additionally, the public user's location can be manually indicated by the public user by tapping/clicking their location on the display of the map. The coordinate of the tap or click event with reference to the map can be used to represent the user's location in the location, (such as at the store, venue, and/or facility) (223).

In one embodiment, if the public user desires, and the information of each data item is sufficient, augmented reality techniques can utilize the device's camera to interpret frames in a video stream. Matching key points and images, the application provider may already have stored for this data point (224). Some examples of this embodiment include artwork at a museum. In one example, a user may search for a particular piece of art or an artist's works and choose a piece of art that the application provider has the image stored or linked to its database. When the user follows the map and arrives in the vicinity, the application provider may use computer vision recognition algorithms and AR (augmented reality) techniques to overlay information on top of the video stream display to assist the user in locating the artwork. Another example for the retail embodiment would help show the user where, on the display, the brand of salsa they searched for is placed, which can be performed using computer vision algorithms and AR techniques. In one embodiment, as further data is entered by the user (or alternatively, ascertained by the device), an iterative process may provide a more accurate location of said item. Moreover, maps of the shortest routes may be recalculated iteratively after items are located (or new items added or items deleted from a list).

Accordingly, in an embodiment, the whole process can be repeated for further searching (221). All data derived for these searches and list functions can be gathered and stored for further analysis and reporting as outlined in the data mining, analysis, and reporting section of this document.

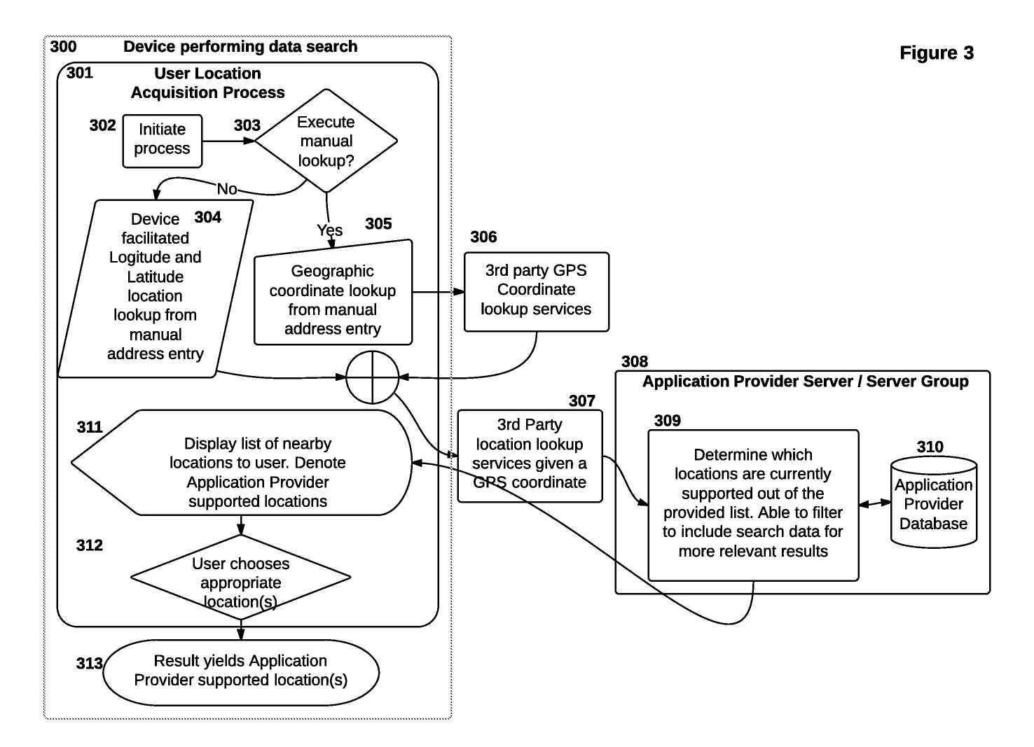

### FIG. 3: Public User's Location Acquisition—FIG. 3.

In one embodiment, the process of the present invention may acquire a user's location by any of a plurality of methods, in one variation, the user's location may be a prerequisite to searching for data. A location for the application provider is any area that has a map to represent it and data for that map with some sort of arrangement in relation to the map. One option to acquire the location is to use a GPS receiver or Location Services system of the device if it has them. In an embodiment and as shown in FIG. 3, the present invention may determine a user's longitude and latitude by using wireless internet points such as used by iPhones. (304) When, the system and methods of the present invention are provided this longitude and latitude, a search against a 3rd party web service can return information about locations using these coordinates.

Alternatively, the user can manually enter the address or other uniquely identifying information (305) which can be queried against 3rd party services to return a geographic coordinate (longitude and latitude) (306). In an embodiment, the present invention may allow an iterative process occur that generates better maps as more information is submitted with the query.

Once a unique ID is obtained tor the location it can be queried against the application provider database where various 3rd party unique identifiers have been recorded for each location. (309)(310)

Because of the lack of accuracy for acquired geographic coordinates inherent to the systems that provide them, a list of “probably/nearby locations” for the coordinate may be provided to the user with the most likely location being listed first. (311) The user chooses the most appropriate location (312) and that result is sent to the next part of the workflow. As more information, is added to the query, the certainty of the most appropriate location increases and a more detailed map may be produced. That is, the bandwidth is used to provide more details about the location when the location is known with more certainty (rather than having the bandwidth used for providing the user with a number of possible locations).

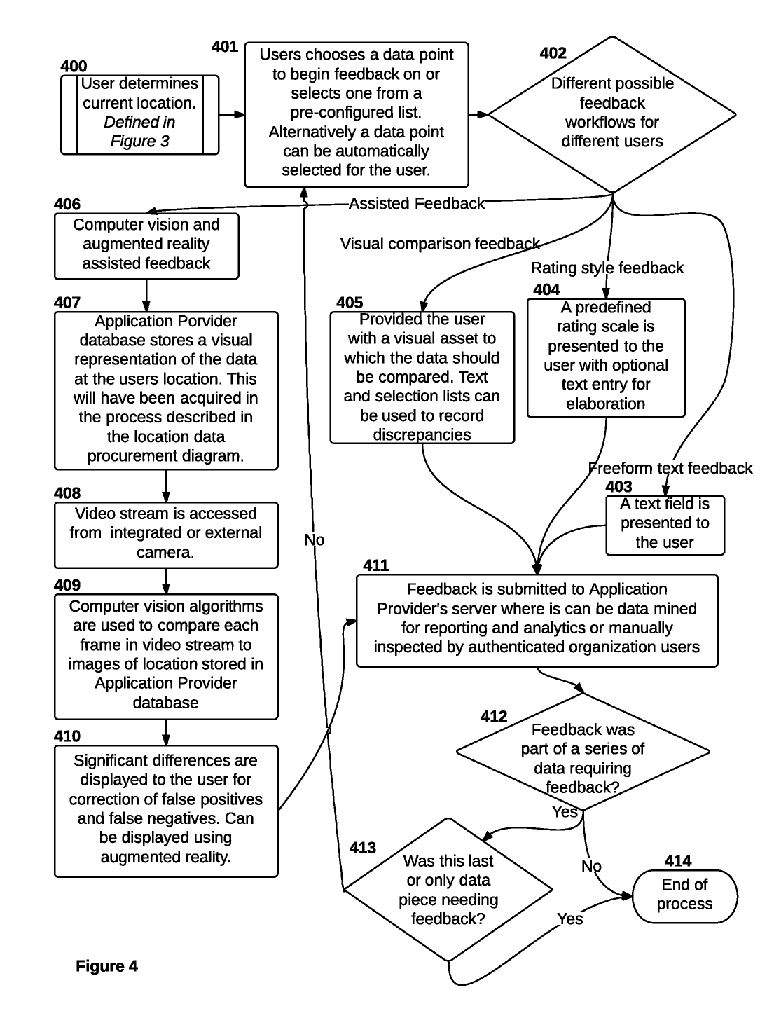

### Data Collection and Feedback Process—FIG. 4.

FIG. 4 shows the part of the application provider's system that allows users to create feedback for information at/about a location. In an embodiment, the present invention may provide different forms of feedback for different users and different organization types. As an example, a form of feedback could be an employee of a retailer performing planogram compliance for shelves/displays in a store. Alternatively and/or additionally, a customer at that same store can make a complaint if a data item is out of stock or not where it is supposed to be as indicated on the map.

In one embodiment and as shown in FIG. 4, the process starts by determining the user's location and searching or selecting the data for which they would like to provide feedback, using the application provider GUI (400, 401). Depending on the user type, a plurality of different feedback workflows can be followed (402). Some are simple and straightforward such as rating on a scale (404), 1-10 or 0-5 stars, or simple manual text entry (403). Alternatively and/or additionally, a checkbox style list may be used, configured by the organization and presented to the user, similar in style and function to a survey (405).

For some embodiments, it will be possible to use computer vision recognition algorithms and augmented reality to help automate feedback (406). An excellent example of this is for planogram compliance where each display has a rendered image from the retailer or planogram vendor of what that display is supposed to look like (407). In one embodiment, the system of the present invention is completely independent from the retailer's site. That is the system is not “built-in” to the retailer's site but rather the system communicates with the retailer's server, or alternatively, with a third party's server for data procurement. In one embodiment, not having the system “built-in” to the retailer's site allows the present system to access sites at a plurality of retailers. One further advantage of the system that is not “built-in” is that one user can access a plurality of retailers while having a single password to access the website.

Given an image of a retailer site, the application provider software can access an integrated or attached camera for the device and start reading each frame of the camera provided video stream (408). Each frame of the camera stream is compared to the image of the planogram and key features are compared according to standard computer vision algorithms (409). Significant differences are displayed to the user for correction of false positives and false negatives (410). The display of these results can be simple graphical representations or can be displayed using augmented reality techniques to overlay visual discrepancies onto the video stream displayed on the device. This process can be used by vendors, with confirmation by the location manager to report shelf space or display infringement by other vendors. A means of reporting these infringements to the offending vendor route staff and/or the appropriate vendor district manager is also provided.

In one embodiment, feedback is submitted to the application provider server where it can be data mined for reporting and analytics or manually inspected by authenticated organization users (411). If the feedback was part of a series of feedback for data at the location the process jumps back to the user(s) being able to choose a data point to begin feedback (401). Otherwise, in one embodiment, the process is finished.

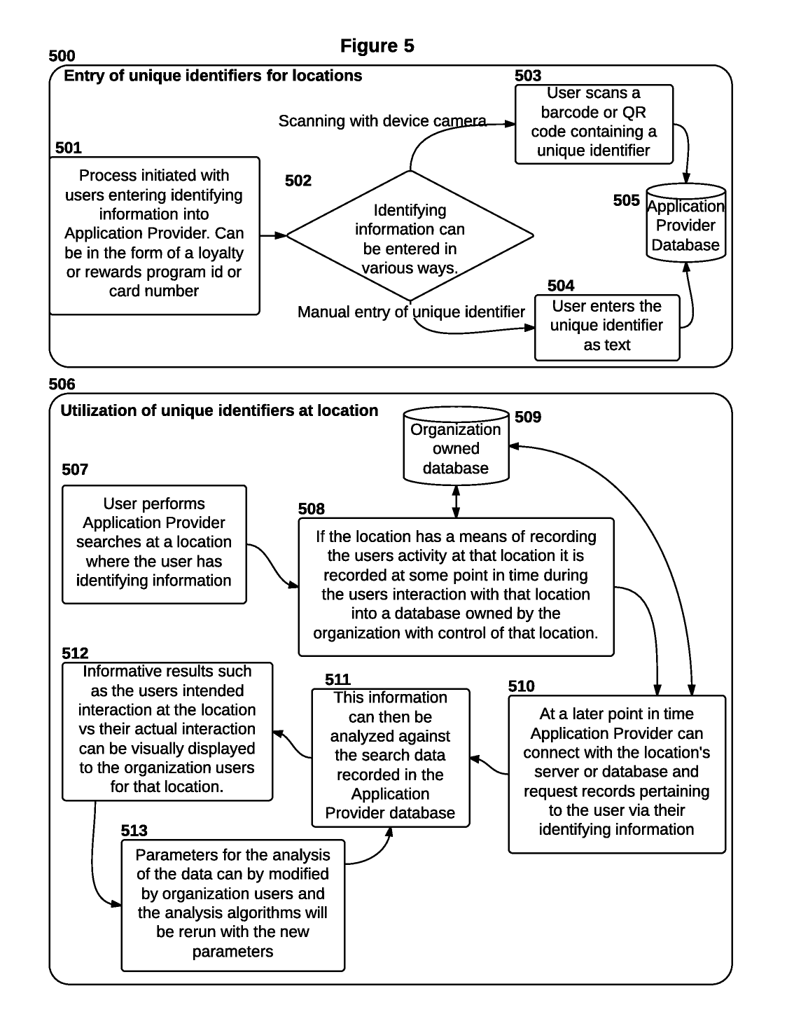

### Data Collection, Analysis, Reporting Process—FIG. 5

Some embodiments of the application provider system make it possible to perform in depth data mining and analysis of public user activity, which can be highly valuable and insightful for the organizational users. In one embodiment, FIG. 5 shows a flow chart that explains this process.

The block (500) describes a process by which a public user's unique identity information can be obtained at an individual location of a participating organization. In the embodiment of retail organization and locations this identifier could be the ID on a loyalty card, manual input by the user, or other means of identifying a public user. One method to enter this information would be to use barcode scanning algorithms and code libraries to scan a card using a camera of a device running application provider software (503). An alternative and/or additional method could be as simple as manual entry of the uniquely identifying information of the user for that organization into the application provider software using the GUI (504). Regardless of the means of the data collection, in one embodiment, it can be stored in the application provider database file associated with that user and recalled anytime that user performs data mining or any other activity.

The block (506) describes the process by which the user's activities at a location and the user's usage of the application provider's system at that location can be analyzed and data mined for useful metrics for an organization. In one embodiment, the process may start with a user performing a search for data at a location where the application provider has uniquely identifying information for the public user and for the organization in control of the location. In one variation, the next piece of the process may be dependent upon the location having a means of recording the public user's activity at that location in some fashion (508, 509). For example, the system may record the products a customer purchased, and in one variation, may record their use of their loyalty card at the retail store or other location where the products were purchased. As another example, the system may record the books a patron checked out at a library checkout using their library card, or alternatively, indicia connected to their smart phone.

In one embodiment at a later point in time an organization user can request metrics/statistic for activity at various locations. The application provider can connect to the organization's server or database and request information on all public users that exist in both the application provider database and the organization database using the customers uniquely identifying information (510). This information can then be analyzed against the search data recorded in the application provider database (511). Informative results such as the users intended activity or purchases at the location, vs. their actual activity or purchases can be visually displayed to the organization users tor that location (512). Parameters for the analysis of the data can be modified by organization users and the analysis algorithms will be rerun with the new parameters (513).

In an embodiment, the present invention relates to systems, products, methods and/or processes of mapping and/or using maps of establishments, such as retail establishments. It should be understood that when a system is discussed, it is contemplated that corresponding products, methods, and/or processes are also contemplated and within the scope of the present invention.

In an embodiment, the present invention relates to mapping one or more retail establishments or other venues such as a county fair, a cruise ship, a hotel, an arena, a concert hail, a hospital, a casino, or other buildings, college campuses, resorts, national and state parks, hiking trails, camp sites, traffic patterns, or other venues that are mapped. In an embodiment, the present invention relates to a system of mapping a retail establishment by one or more users, said system comprising creating, gathering and/or editing data from one or more of a store web site, a third party vendor, or manual input from said one or more users, wherein the store web site, the third party vendor or the manual input from said one or more users operationally communicates with a graphical user interlace of a main server, the graphical user interface able to facilitate generation of the mapping of the retail establishment by using input of one or more data points to create a database, said one or more data points being gathered and/or input directly or indirectly by the store web site, the third party vendor, or manual input from the one or more users. In one variation, the system displays the one or more data points from the database as a map of a retail establishment that can be viewed by said one or more users. In a variation, the mapping of the retail establishment is displayed on a computer or on a smart phone. Alternatively, the mapping of the retail establishment can be displayed on a computer-like device such as an IPad, an IPod, Google glasses, and/or on a smart phone

In an embodiment, the one or more users access said database by input of an username and/or a password. In a variation, the system of the present invention uses data points that are generated from planograms or crowdsourcing. In an embodiment, the one or more users that use the system of the present invention are able to search the database for one or more maps of one or more retail establishments. In a variation, the one or more users can search the database to show a route from a current location to one or more desired locations. For example, the one or more users may have a route displayed that takes the user from their current location to the location of a particular good or service in a retail establishment. Not only may a route be provided, but the mapping display may also indicate whether or not goods are present at the location. For example, if a product has been bought out, the display may indicate that there are none of those products at the location where the product normally can be found. In one variation, however, the display may indicate that there is a similar or corresponding product at that location or at some other location.

In one embodiment, the route may be updated iteratively. As additional data is entered into an application, the route may become more precise or it may change depending on information entered by said one or more users.

In one embodiment, the route may be generated from data provided by scanning devices and/or software. For example, a bar code scanner may be able to scan a product while at the same time provide information as to the products location (or alternatively information related to the information may be entered by said one or more users). The software can use this information to give the one or more users a route to the desired good or service (or alternatively, it may provide a better or improved route to the desired good or service).

In one embodiment, the system may use one or more of advanced augmented reality, light detection and ranging, robot mapping, and/or radio frequency technologies to determine the route.

In an embodiment, the system may allow additional data points to be generated by a comparison using a computer vision algorithm that compares frames in a video stream with the one or more data points stored in the database. The system may then use the computer vision algorithm to display differences between data that is in the data base and the newly incorporated data that comes from the frames in the video stream. The software may be able to display differences or significant differences between the additional one or more data points and the one or more data points. The application may have software associated with it that allows an iterative process to occur that generates a map based upon what is the “best” data. For example, a method may be employed that provides a map that gives emphasis to data that is corroborated data. In one variation, the raw data may also be stored in application data storage device so that when additional new data is input, a “better” map can be generated.

In an embodiment, the application may provide a user with one or more data points that may further comprise information/indicia related to one or more of raising revenue, offering better service to the public, auditing emergency procedures, inventorying goods and/or products, studying the effects of marketing, testing the effectiveness of staging, reducing costs, and/or evaluating vender and/or service providers or providing other services.

In an embodiment, the present invention relates to a method of creating and/or using a map of a retail establishment by one or more users comprising: accessing an application that is operationally linked to a graphical user interlace of a server of an application provider, said one or more users optionally inputting new data to create said map and/or to use said map, wherein said new data includes indicia about a location of said one or more users or of one or more products, running said new data through a computer algorithm on said server that compares said new data to old data on the server, or stores and/or processes said new data to generate a database, wherein said database is then used to create a map of a retail establishment that can be accessed by said one or more users.

In an embodiment, the method derives the old data from a planogram. Alternatively, the old data may be obtained from information from crowdsourcing or alternatively and/or additionally, from data and/or information input by individuals.

In an embodiment, the method uses an application that is present on a smart phone. Alternatively, the application may be present on a computer or on a smart phone. Alternatively, the application may be present on an Ipad, on an Ipod, or on Google glasses.

In an embodiment, the method may have the one or more users access said application by input of an username and/or a password.

In an embodiment, the method may have an application that is able to display one or more routes to one or more products from the location of one or more users using new data input by the user. The route(s) may be to another retail establishment. For example, if one retail establishment does not have the desired product (e.g., the product may be out of stock), the application may show a route that takes the user to another retail establishment that has the product in stock. Accordingly, the method may involve an application that not only has data that relates to routes but may also keep track of inventories at various retail establishments.

In one embodiment, the method may involve the display of routes that is an iterative process. For example, as the user inputs new data (e.g., such as a new location), the method of the present invention may have an embodiment that updates routes so that a better (e.g., shorter) route is mapped taking the user to a new location.

In an embodiment, the method may use a database that stores data. When new data s entered, it may pass through an algorithm that uses both the new and the old data. In one embodiment, the new and old data may be derived at least in part by information gleaned from an integrated or external camera(s). The method may use an application that has a computer vision algorithm that compares frames in a video stream with the one or more data points stored on the database. By using this comparison, in one embodiment, the method is able to use an application that presents a route.

It should be understood that the present invention is not to be limited by the above description. Modifications can be made to the above without departing from the spirit and scope of the invention. It is contemplated and therefore within the scope of the present invention that any feature that is described above can be combined with any other feature that is described above. Moreover, it should be understood that the present invention contemplates minor modifications that can be made to the products, systems, and methods of the present invention. When a feature is discussed amongst a group of features, the present invention contemplates that each or any of those features may be singled out (e.g., the other features may be disclaimed). The scope of protection to be afforded is to be determined by the claims which follow and the breadth of interpretation which the law allows.

We claim:

1. A system of mapping a retail establishment by one or more users, said system comprising creating, gathering and/or editing data from one or more of a store web site, a third party vendor, or manual input from said one or more users, wherein the store web site, the third party vendor or the manual input from said one or more users operationally communicates with a graphical user interface of a main server, the graphical user interface able to facilitate generation of the mapping of the retail establishment by using input of one or more data points to create a database, said one or more data points being gathered and/or input directly or indirectly by the store web site, the third party vendor, or manual input from the one or more users.

2. The system of claim 1, wherein the system displays the one or more data points from the database as a map of a retail establishment that can be viewed by said one or more users.

3. The system of claim 2, wherein the mapping of the retail establishment is displayed on a computer or on a smart phone.

4. The system of claim 2, wherein the one or more users access said database by input of an username and/or a password.

5. The system of claim 1, wherein the data points are generated, from planograms or crowdsourcing.

6. The system of claim 1, wherein said one or more users are able to search the database for one or more maps of one or more retail establishments.

7. The system of claim 6, wherein the one or more users can search the database to show a route from a current location to one or more desired locations.

8. The system of claim 7, wherein the route is updated iteratively.

9. The system of claim 7, wherein the route is generated from data provided by scanning devices and/or software.

10. The system of claim 9, wherein one or more of advanced augmented reality, light detection and ranging, robot mapping, and/or radio frequency technologies are used to determine the route.

11. The system of claim 1, wherein additional one or more data points are generated by a comparison using a computer vision algorithm that compare frames in a video stream with the one or more data points stored on the database.

12. The system of claim 11, wherein significant differences are displayed between the additional one or more data points and the one or more data points.

13. The system of claim 1, wherein said one or more data points further comprise information related to one or more of raising revenue, offering better service to the public, auditing emergency procedures, inventorying goods and/or products, studying the effects of marketing, testing the effectiveness of staging, reducing costs, and/or evaluating vender and/or service providers.

14. A method of creating and/or using a map of a retail establishment by one or more users comprising: accessing an application that is operationally linked to a graphical user interface of a server of an application provider, said one or more users optionally inputting new data to create said map and/or to use said map, wherein said new data includes indicia about a location of said one or more users or of one or more products, running said new data through a computer algorithm on said server that compares said new data to old data on the server, or stores and/or processes said new data to generate a database, wherein said database is then used to create a map of a retail establishment that can be accessed by said one or more users.

15. The method of claim 14, wherein said old data is information obtained from a planogram.

16. The method of claim 14, wherein the application is present on a computer or on a smart phone.

17. The method of claim 14, wherein the one or more users access said application by input of an username and/or a password.

18. The method of claim 14, wherein said application is able to display one or more routes to said one or more products from the location of said one or more users using said new data.

19. The method, of claim 18, wherein said display is an iterative process.

20. The method of claim 14, wherein said, old data or said new data is derived at least in part by information gleaned from an integrated or external camera.
